(19) United States
(12) Patent Application Publication
(10) Pub. No.: US 2006/0156998 A1
(43) Pub. Date: Jul. 20, 2006

(54) Protective collar for animals

(76) Inventors: Shawn Bridy, Wayne, PA (US); Ezra Felker, Drexel Hill, PA (US); Mark J. Rosen, Bryn Mawr, PA (US)

Correspondence Address: MARK J. ROSEN P.C., 418 BARCLAY ROAD, BRYN MAWR, PA, 19010, US

(21) Appl. No.: 11/335,489

(22) Filed: Jan. 19, 2006

Related U.S. Application Data
(60) Provisional application No. 60/644,909, filed on Jan. 19, 2005.

(51) Int. Cl. A01K 15/04

(52) U.S. Cl. 119/831

(57) ABSTRACT

The invention relates to a protective collar device for an animal recovering from a wound or other insult, which prevents the animal from biting, licking, nibbling, and chewing the site of an injury, wound, sutures, bandages, and the like. The protective collar of the invention has a shield fastened at the throat to a traditional collar by longitudinal straps, or by a trough-shaped material.

### RELATED APPLICATIONS

This application claims the benefit, under 35 USC §119(e), of U.S. Provisional Patent Application U.S. 60/644,909 filed 19 Jan. 2005.

### FIELD OF THE INVENTION

The invention relates to a protective collar device for an animal recovering from a wound or other insult, which prevents the animal from self-inflicted further injury, and prevents the animal from biting, licking, nibbling, and chewing the site of the injury, wound, sutures, bandages, and the like. The collar of the invention also relates to preventing animals from chewing items, such as carpets, furniture, toys, etc., when left alone.

### BACKGROUND OF THE INVENTION

Household pets routinely lick or nibble at wounds, sores, rashes, sutures, flea bites and other afflicted portions of their bodies. This propensity can not only retard the healing process but may also lead to complications which require further veterinary attention. Therefore, unless the animal is immobilized, it must be prevented from reaching the affected area with its mouth.

Household pets, especially juveniles during teething, often chew or nibble on unsanctioned items such as furniture, shoes, carpet, pillows, toys, and the like. One common device for such prevention is the Elizabethan collar described in U.S. Pat. No. 3,036,554. The Elizabethan collar comprises a disk in the form of a truncated cone fitted around the animal's neck which prevents the animal from reaching its body with its mouth. Such collars, however, are cumbersome devices, and they interfere with the ability of the animal to sleep, eat, and drink. They also obscure the animal's peripheral vision and interfere with its mobility, making it difficult to run, jump, climb stairs, and maneuver around corners and through narrow spaces. An exploring animal may also damage household furniture through repeated collisions. An animal wearing the collar also encounters frustration when the collar impedes its ability to move in routine ways, jolting to a stop when the collar encounters an immovable object, such as the aforementioned furniture. Many domestic dogs are placed in crates at various times of day, and the Elizabethan collar prevents them from being able to move in their crates, as the collars are quite large. The collar also imposes a barrier between the animal and its owner, inhibiting the owner from holding the animal and inhibiting the animal from jumping up on the owner. Finally, Elizabethan collars are unsightly and can be a source of embarrassment to the owner. Other similar collars are described in U.S. Pat. Nos. 3,013,530 and 3,072,098. An inflatable version which may be installed on an animal without passing the collar over its head is described in U.S. Pat. No. 6,659,046.

U.S. Pat. No. 5,197,414 provides a protective collar made of a perforated material supported by ribs, with an attached grip positioned to provide a groomer a firm hold on the animal's head so as to avoid being bitten while grooming.

A collar comprising a pillow with a central aperture is described in U.S. Pat. No. 6,044,802, wherein the pillow is passed over the animal's head and cinched with a drawstring.

Another type of collar is described in U.S. Pat. Nos. 5,307,764 and 5,469,814. This collar is a cylindrical device extending from the animal's mandible to its scapula, thereby preventing the animal from turning its head with full range of motion. The limited range of motion prevents the animal from being able to access the affected area with its teeth. However, the limited range of motion has undesirable effects to the animal's peripheral vision because the animal is unable to turn its head sufficiently to the sides. Additionally, the collar also suffers the unsightliness and potential embarrassment presented by the Elizabethan collar and the others described above.

The art is in need of a superior collar which prevents the animal from having chewing or nibbling access to the affected area, as well as from being unable to chew or nibble unsanctioned items, but without the undesirable effects of current protective collars.

### SUMMARY OF THE INVENTION

The invention provides a superior protective collar which avoids the undesirable effects of current collars based on the discovery that nibbling by an animal may be prevented by insuring that the animal's upper and lower teeth are unable to have access to an affected area or unsanctioned object. This is accomplished by impeding the upper and lower teeth from being able to grasp an area or object via the positioning of a device which blocks such access.

In one aspect, the invention comprises a shield extending from above the animal's upper teeth to below its lower teeth. The shield is fastened around the animal's mouth by fastening means positioned around the animal's snout and extended to its neck where a traditional collar secures the device on the animal. The front portion of the shield allows the animal to open its mouth, but the upper and lower teeth are unable to grasp or nibble at an affected area of the animal's body by the blocking effect of the member. The animal has full freedom of motion, may open its mouth, but may not nibble. The shield may be formed from a soft, flexible material, providing the full benefits of the invention and a minimum of discomfort. In some embodiments, the member's material is reinforced with one or more ribs formed from wire, plastic, rubber, or the like, which provide a firmer shield.

In another aspect, a trough shape secured beneath the animal's head by at least one fastener extends from the front portion shield, and fully prevents the animal from nibbling and licking an injury site while permitting the animal full freedom of motion. Again, the animal may open its mouth, but the barrier formed by the front portion of the trough member prevents the animal from having access to an affected area or unsanctioned object. The trough may be a single piece formed from a firm material, and may be shaped as a trough which cups around the animal's lower jaw, fastened to the animal in at least one place: a fastening device around the jaw passing around the muzzle or snout, or at the rear end, the collar may be fastened with a traditional collar device, or may be secured around the head of the animal by the rear portion of the trough form itself, extended laterally around the head. The protective collar may be fastened both at the rear and around the snout or muzzle.

In both the shield and the trough devices of the invention, the animal's teeth are prevented from grasping or nibbling at an affected area or unsanctioned objects.

### BRIEF DESCRIPTION OF THE DRAWINGS

FIG. 1 is an illustration of an embodiment of the protective collar of the invention employing a shield device, shown as worn by a dog.

FIG. 2 is an illustration of another embodiment of the protective collar of the invention employing a trough device, shown as worn by a dog.

FIG. 3 is an illustration of another embodiment of the protective collar of the invention employing a trough device.

FIG. 4 is an illustration of another embodiment of the protective collar of the invention, with a deeper trough.

### DETAILED DESCRIPTION OF THE INVENTION

The invention provides a superior protective collar which avoids the undesirable effects of current collars based on the discovery that nibbling by an animal may be prevented by insuring that the animal's upper and lower teeth are unable to have access to an affected area or unsanctioned object. This is accomplished by impeding the upper and lower teeth from being able to grasp an area or object via the positioning of a device which blocks such access.

In one embodiment, the invention comprises a shield extending from above the animal's upper teeth to below its lower teeth. The shield is fastened around the animal's mouth by fastening means positioned around the animal's snout and extended to its neck where a traditional collar secures the device on the animal. The front portion of the shield allows the animal to open its mouth, but the upper and lower teeth are unable to grasp or nibble at an affected area of the animal's body by the blocking effect of the shield. The animal has full freedom of motion, may open its mouth, but may not nibble. The shield may be formed from a soft, flexible material, providing the full benefits of the invention and a minimum of discomfort. In some embodiments, the member's material is reinforced with one or more ribs formed from wire, plastic, or the like, which provide a firmer shield.

The shield may be formed from any flexible or firm material in the art, so long as it is sufficiently firm to resist displacement by the animal. Preferred materials for the shield itself include nylon, cotton web, leather, neoprene, or the like. These materials provide comfort and stiffness, however, if additional stiffness is required, depending on the animal species and breed, the shield may be reinforced by ribs, wires, and the like which promote retention of the shape of the shield and prevent displacement of the device.

The shield may be extended coextensively with the portion of the device which traverses the upper region of the animal's snout, forming a single toroidal member. Alternatively, the shield may comprise only the front portion of the device, in which case the portion traversing the animal's snout is constructed from nylon, cotton web, leather, neoprene, or the like and is attached to the shield on either side of the shield.

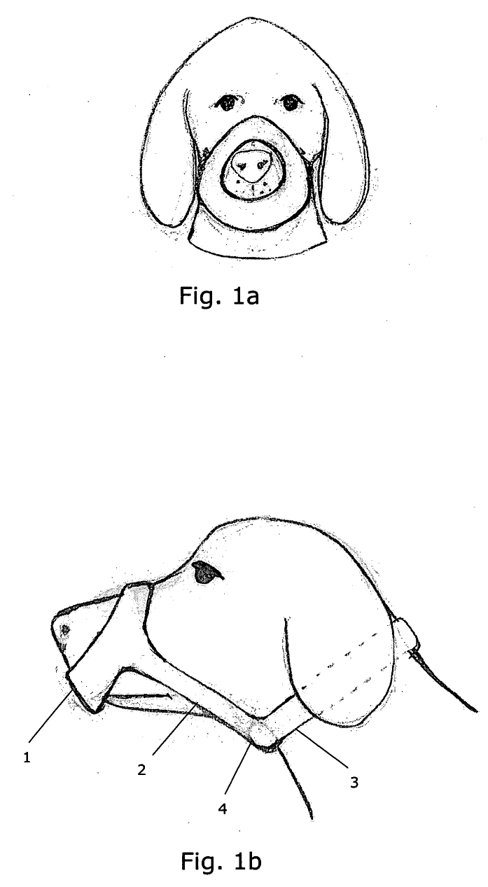

As shown in FIG. 1b, the shield (1) may be secured to the animal by two longitudinal straps (2) made of the same or similar material, which join to a traditional collar (3) at a position in the front of the throat, the joining region being identified in FIG. 1b as (4). This arrangement prevents the device from rotating about the animal's head, and keeps the shield securely in place preventing the animal from nibbling. As shown in FIG. 1a and 1b, the shield effectively blocks the upper teeth from reaching any object, including the animal's own skin, and the lower teeth are likewise prevented from reaching objects by virtue of the lower edge of the shield. The animal, however, is free to open it's mouth.

The length of the longitudinal straps may be adjustable in some embodiments, using velcro or the like. More preferably, the collar is provided with a ring or double-ring through which both straps are passed and joined with a compression buckle which adjusts the length of the straps to suit the animal.

Generally, the longitudinal straps are between ⅛ of an inch and 1 inch wide, depending on the size of the animal intended to wear the collar. The collar around the neck is of similar width. The length of the straps may vary between about an inch for smaller animals, to several inches for larger animals. The shield may vary between about ½ inch to 3 or more inches in front, tapering to from about ½ inch to about 2 inches in the region encircling the top of the animal's snout. Those of skill in the art will appreciate that various combinations of actual dimensions will be suitable for particular animals, and these combinations are intended to be within the scope of the invention.

In one preferred embodiment, the shield is constructed of neoprene or reinforced neoprene, fastened at each of its lateral sides to straps comprising nylon webbing, the two straps of nylon webbing joining at the throat of the animal to a nylon collar worn around the neck. This embodiment demonstrates several advantages of the invention, particularly the use of a comfortable device for effective prevention of nibbling while at the same time permitting full freedom of mobility, without the use of an Elizabethan collar and its attendant disadvantages.

In another embodiment of the invention, a trough shape secured beneath the animal's head by at least one fastener extends from the front portion shield, and fully prevents the animal from nibbling and licking an injury site while permitting the animal full freedom of motion. Again, the animal may open its mouth, but the barrier formed by the front portion of the trough member prevents the animal from having access to an affected area or unsanctioned object. The trough may be a single piece formed from a firm material, and may be shaped as a trough which cups around the animal's lower jaw, fastened to the animal in at least one place: a fastening device around the jaw passing around the muzzle or snout, or at the rear end, the collar may be fastened with a traditional collar device, or may be secured around the head of the animal by the rear portion of the trough form itself, extended laterally around the head. The protective collar may be fastened both at the rear and around the snout or muzzle.

The trough may be constructed from any firm material, however, a firm and somewhat flexible material is preferred in order to allow the trough to be better formed to the shape of the animal's lower head. In a preferred embodiment, the trough is constructed from plastic, more preferably from polyethylene, polypropylene, or polystyrene. The trough is formed from a firm material, such as plastic, ranging in thickness from about 1/64 inch to about ½ inch. Preferably the trough is 1/16, ⅛, or ¼ inch thick.

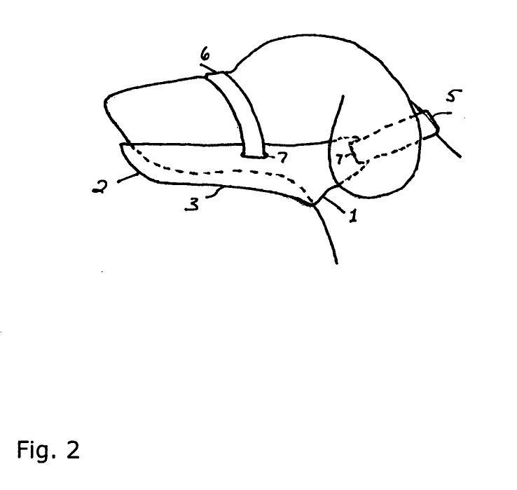

The trough may be formed from a single piece of firm material, or may be formed by gluing or otherwise fastening several pieces together to achieve the final shaped trough. The trough has a forward end comprising a raised lip at the front end. The trough also has raised sides, and a rear end. The longitudinal length of the trough is chosen to fit the animal's head. The trough also has an inner surface, and an outer surface. The longitudinal portion of the trough may be cut out along the lower length of the surface, thereby allowing for drainage as well as being lighter in weight. FIGS. 2-4 depict such an embodiment, wherein the sides of the trough remain raised and secure the animal's head, but there is no lower surface between the neck portion and the front lip portion. Such a trough is referred to herein as a V-trough.

Alternatively, the trough's lower surface may be perforated with small holes which allow for drainage and lighter weight but which do not compromise the structural integrity of the protective collar. Such perforations may range in diameter from about 1 mm to about 4 cm. Alternatively, the perforations may be in the form of slits.

FIG. 2 illustrates a preferred embodiment of the invention employing a trough. In FIG. 2, the rear end of the device (1), at the back of the jaw, may be padded with a strip of softer material to enhance the comfort of the device. The front shield portion of the device (2) is shaped whereby the lip is sufficiently extended such that the upper edge is at or above the level of the animal's lower teeth, thereby preventing the animal from nibbling its affected areas. The lip's depth ranges from about ½ inch to about 4 inches. The animal's tongue is also prevented by the lip from being extended longitudinally straight out, thereby preventing the animal from licking its affected areas.

The longitudinal length of the trough shape (3) is chosen to fit the length of the animal's jaw, such that the device reaches from just outside the front end of the lower jaw, along the bottom of the jaw, to the rear end of the jaw. This length is in the range of from about 3 inches to about 16 inches, depending on the size of the animal. The sides of the trough shape (4) are of sufficient depth so as to prevent the device from rotating around the jaw, and are in the range of from about ½ inch to about 4 inches in depth. The sides of the device also serve to increase its rigidity.

The first and second means for fastening (5 and 6) the trough to the animal's head may be passed completely around the device, secured to the trough by velcro, snaps, or the like. Alternatively, either or both of the fastener means may pass through slits in the trough (7). The fastener means are thereby securely coupled to the trough, and allow for secure fastening around the animal's head. Preferred fastening devices include collars comprising nylon, cotton web, leather, neoprene, or the like. The width of the two means for fastening will vary depending on the size of the animal, but will generally be in the range of between ¼ inch and 2 inches, preferably about 1 inch. The first means for fastening may be the same width as the second means, however, generally the first means will be wider. The two ends of each of the fastening devices are preferably secured around the animal's neck and snout with velcro, buckles, ties, or more preferably with quick-release compression buckles. The first means for fastening (5) secures the rear end of the trough around the neck of the animal, while the second means for fastening (6) secures the middle portion of the trough around the muzzle or snout of the animal. The location along the longitudinal axis of the trough for the second fastening means may be located forward on the trough so long as it does not require positioning on the nose of the animal to secure it to the animal's head. It may be positioned to the rear so long as it maintains a secure fit to the animal's head without needing to passed over the eyes, and without allowing the forward leading edge end of the trough to dip below the level needed to restrain the animal's lower teeth. In a preferred embodiment, the second means of fastening is located at about the center of the trough, whereby the fastening means encircles the snout of the animal approximately at the midpoint between the nose and eyes.

In one preferred embodiment, the rear end of the trough has a strip of soft material attached thereto to provide a more comfortable fit to the animal. In another preferred embodiment, the inner surface of the trough is lined with a soft material further enhancing comfort. In another preferred embodiment, the entire firm material is disposed within a shell of softer material, thereby providing a more comfortable protective collar. In this embodiment, the means for fastening may pass through both the trough and the shell, or may pass through just the shell, or may be attached to the shell via velcro, snaps, and the like. The soft material may be nylon, cotton, foam, neoprene, or other suitable material, and may be padded if desired.

In another preferred embodiment, the rear fastening means is formed from lateral extensions of the trough form itself, as shown in the mockup depicted in FIGS. 6-9. In this embodiment, there is no front fastening device, as the rear fastener accomplishes securing the collar to the animal. Further, should the animal attempt to pull on the front piece of the trough form with its paw, the animal's head will be forced downward without allowing the animal to remove the trough form from the front of its muzzle, thereby preventing escape from the collar. This embodiment may also employ the various additional elements of padding and the variety of fastening devices which may be used to attach the lateral extension forms around the head securely.

In another preferred embodiment of the invention, the protective collar is secured both by a front fastening device as described above and a rear fastening device formed from lateral extensions of the trough form, as described above.

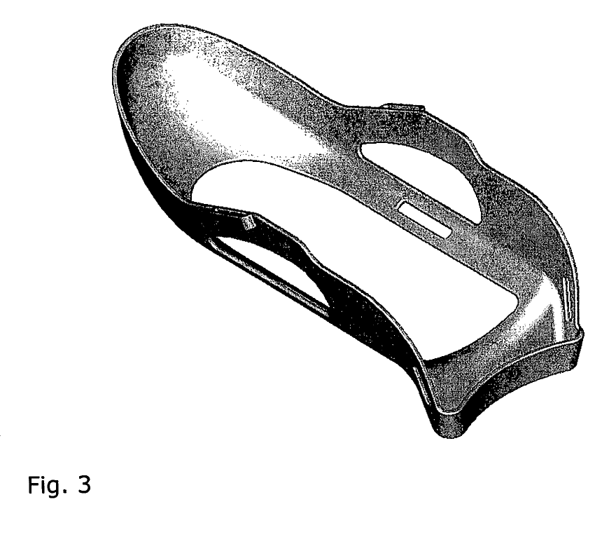

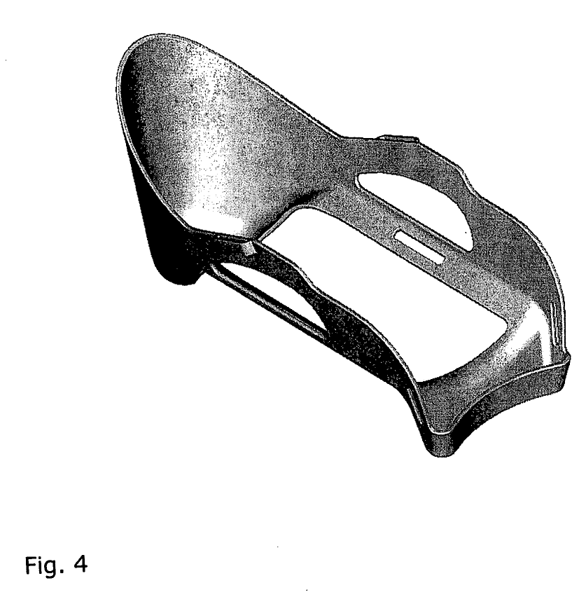

In the embodiments depicted in FIGS. 3 and 4, the device is constructed from plastic through layer-by-layer deposition and includes slots for attaching the fastening means.

Some of the advantages of the protective collar of the invention include unimpeded peripheral vision, unimpeded mobility, while preventing the animal from chewing its own affected areas as well as unsanctioned items. Unlike Elizabethan collars and other current collars, the present invention allows full range of motion for the animal, including within the animal's crate.

The protective collar of this invention is suitable for use with most mammals, including domestic dogs, cats, and other household pets, as well as any animal whose head needs to be restrained in order to prevent it from injuring itself.

All references cited in this application are hereby incorporated as if fully set forth herein. The foregoing embodiments are to be considered as illustrative only, the full scope of the invention being defined by the appended claims.

We claim:

1. A protective collar for an animal in need thereof, comprising a shield and a means for fastening the shield to the animal's head.

2. The protective collar of claim 1, wherein the means for fastening comprises two longitudinal straps joined to a neck collar.

3. The protective collar of claim 1, wherein the shield comprises a member selected from the group consisting of nylon, cotton web, leather, and neoprene.

4. The protective collar of claim 3, wherein the shield comprises neoprene.

5. The protective collar of claim 4, wherein the neoprene is reinforced with ribs comprising a member selected from the group consisting of wire, plastic, and rubber.

6. The protective collar of claim 2, wherein the longitudinal straps comprise nylon or cotton webbing.

7. The protective collar of claim 2, wherein the longitudinal straps are joined to the neck collar by a double ring through which the longitudinal straps pass and are secured by a compression buckle.

8. A protective collar for an animal in need thereof, comprising a trough and a means for fastening the trough to the animal's head.

9. The protective collar of claim 8, wherein the trough comprises plastic.

10. The protective collar of claim 8, wherein the trough is disposed within a soft material.

11. The protective collar of claim 8, wherein the means for fastening comprises nylon with a quick release buckle.

12. The protective collar of claim 8, wherein the means for fastening comprises lateral extensions of the trough.

13. The protective collar of claim 12 which has no forward means for fastening.

14. The protective collar of claim 8 which has a forward means for fastening.

15. The protective collar of claim 8 which has perforations in the trough.

16. The protective collar of claim 8 wherein the trough is a V trough.
